(19) United States
(12) Patent Application Publication
(10) Pub. No.: US 2022/0277364 A1
(43) Pub. Date: Sep. 1, 2022

(54) SYSTEM AND METHOD FOR DETERMINING ATTRIBUTES OF A TRAVEL ROUTE INVOLVING SLK LOCATION(S)

(71) Applicant: SLK MATE PTY LTD, Dumbleyung (AU)

(72) Inventors: Emily EDWARDS, Dumbleyung (AU); Bevan EDWARDS, Dumbleyung (AU)

(73) Assignee: SLK MATE PTY LTD, Dumbleyung (AU)

(21) Appl. No.: 17/680,841

(22) Filed: Feb. 25, 2022

(30) Foreign Application Priority Data
Feb. 26, 2021 (AU) 2021900539

(51) Int. Cl. G06Q 30/02; G06Q 10/08; G01C 21/34; G01C 21/36

(52) U.S. Cl. CPC G06Q 30/0284; G06Q 10/083; G01C 21/3407; G01C 21/3605

(57) ABSTRACT

Location data is received that includes information relating to a start location and a destination location. The start location and/or destination location is an SLK location and does not include coordinate values that enable calculation of a distance to/from the SLK location(s). A first application programming interface (API) is queried for validation of information relating to the SLK location(s) and for coordinate values associated with any SLK location(s). Based upon validation of information relating to the SLK location(s), the coordinate values associated with the SLK location(s) is received. Based on the received coordinate values, determined is attribute(s) associated with travel between the locations including: at least one travel route between the start and destination locations, at least one travel route determined by querying a second API. The attributes associated with travel between the locations is inserted into content displayed on a graphical user interface associated with the device.

### FIELD OF THE INVENTION

The present invention relates to a system and method for determining one or more attributes associated with travel between two locations (of which at least one is a Straight Line Kilometre (SLK) location), including determination of at least one travel route between the two locations, wherein the attribute(s) are entered into a computing device with the assistance of a graphical user interface (GUI).

### BACKGROUND OF THE INVENTION

Devices and associated software applications for displaying maps and travel route attributes are known, including for example Google Maps®. Such software applications allow a user to determine their location at a predefined physical address. Further, such applications may enable a user to select another physical address, such as a destination location, for the purpose of determining a distance between addresses as well as other attributes including travel route options/recommendations, estimated arrival time (depending on the mode of transport), etc.

However, such devices and/or software applications are deficient when a user attempts to determine attributes associated with a travel route in which one or both of the start and destination locations do not have a physical address. Locations which do not have a physical address but for which latitude and longitude coordinates may be identified (e.g. using a Global Positioning System (GPS)) are often referred to, and are identified herein, as “SLK locations”.

Devices and/or software applications capable of providing a user with the ability to access information associated with an SLK location exist, e.g. an online SLK meter may provide latitude and longitude coordinates based on information entered by a user provided the device is located in an area where Global Positioning System (GPS) is available. However, determining a travel route between two locations of which at least one is an SLK location, and calculating additional attributes associated with the travel route (such as distance, freight cost estimates, etc), is achieved predominantly manually and is known to be cumbersome, time consuming and has the potential to inaccurate determinations particularly in circumstances where there are multiple destination locations. Since calculation of additional attributes associated with travel between two locations, of which at least one is an SLK location, is dependent upon the determined travel route between the locations, it is important for the travel route to be determined efficiently and accurately.

In a practical example, a travel route for a concrete dump truck driver may involve multiple concrete dump points along a road that is being re-sealed. At present, whilst coordinates associated with each dump point (SLK locations having no physical address) can be obtained, there is no device and/or software application known to the Applicant that can assist with determining a travel route between a start location and subsequently each destination location in an efficient, accurate and user friendly manner that efficiently utilises computer and network resources. The same deficiencies exist, with respect to devices and/or software applications known to the Applicant, regarding presentation of attributes associated with travel along the determined travel route.

Accordingly, the Applicant is not aware of any device and/or software application that enables a user to, in addition to reporting the longitude and latitude coordinates associated with a live SLK location, determine, and present to the user, a travel route and attributes associated with travel between two locations (of which at least one is an SLK location), e.g. an optimal travel route in the case of multiple travel route options, an indication of distance (straight line kilometre or actual travel distance) between the locations, guided navigation to the destination, estimated time of arrival, freight cost estimation, and couriercost quotations for collection from, and delivery to, one or more locations.

The present invention seeks to mitigate one or more of the problems discussed herein, or at least seeks to provide an alternative solution.

The reference to any prior art in this specification is not, and should not be taken as, an acknowledgement or any suggestion, that the prior art forms part of the common general knowledge.

### SUMMARY OF THE INVENTION

In one aspect, the present invention provides a computer-implemented method including receiving, by one or more processors associated with a device, location data, wherein the location data includes data input by a user of the device, determining, by the one or more processors, that the location data includes information relating to a start location and a destination location, wherein at least one of the start location and destination location is an SLK location and hence does not include coordinate values that enable calculation of a distance to/from the SLK location(s), querying, by the one or more processors, a first application programming interface (API) for validation of information relating to the SLK location(s) and for coordinate values associated with the SLK location(s), receiving, by the one or more processors, based upon validation of information relating to the SLK location(s), the coordinate values associated with the SLK location(s), determining, by the one or more processors and based on the received coordinate values, one or more attributes associated with travel between the locations including at least one travel route between the start and destination locations, the at least one travel route determined by querying a second API, and inserting, by the one or more processors, into content displayed on a graphical user interface (GUI) associated with the device, the one or more attributes associated with travel between the locations.

In an embodiment, determination of the one or more attributes is based at least on coordinate values associated with each of the start location and destination location.

In an embodiment, the method further includes:

determining, by the one or more processors, that coordinate values associated with the start location are not available based on data input by the user or stored in memory, and

querying, by the one or more processors, a third API for validation of information relating to the start location and for coordinate values associated with the start location.

In an embodiment, the coordinate values associated with each of the start and destination locations represent longitude and latitude coordinates of a Global Positioning System (GPS).

In an embodiment, the one or more attributes further include a distance between the locations based on each of the one or more travel routes, wherein the distance includes:

a straight line kilometre distance between the locations, or

a travel distance between the locations.

In an embodiment, the method further includes:

receiving, by the one or more processors, travel route preference data input by the user of the device, and

when two or more travel routes are determined, selecting, by the one or more processors, an optimal travel route of the two or more travel routes based on the distance between the locations and the preference data.

In an embodiment, the method further includes:

inserting into content displayed on the GUI, by the one or more processors and based upon determination of the one or more travel routes or selection of the optimal travel route, detailed route navigation for guiding the user from a current location to the destination location.

In an embodiment, the method further includes:

receiving, by the one or more processors, consignment data input by the user of the device, the consignment data including one or more freight rates, and

wherein the one or more attributes associated with travel between the locations further includes a freight cost estimate determined based on the distance between the locations and the consignment data including the one or more freight rates.

In an embodiment, the one or more attributes associated with travel between the locations further includes one or more freight quotes based upon quotes retrieved, by the one or more processors, from one or more freight companies based on the consignment data.

In an embodiment, the method further includes:

enabling, by the one or more processors and based upon further input by the user confirming acceptance of a particular freight quote associated with a particular freight company, access to an online freight ordering system associated with the particular freight company.

In an embodiment, receiving location data includes receiving a user selection of a start and destination location on an interactive map displayed on the GUI, wherein the one or more attributes, once determined, are inserted for display on the interactive map.

In an embodiment, the determined one or more attributes associated with travel between the locations further include an estimated time of arrival.

According to a further aspect, the present invention provides a system including one or more computers and one or more storage devices storing instructions that are operable, when executed by the one or more computers, to cause the one or more computers to receive, by one or more processors associated with a device, location data, wherein the location data includes data input by a user of the device, determine, by the one or more processors, that the location data includes information relating to a start location and a destination location, wherein at least one of the start location and destination location is an SLK location and hence does not include coordinate values that enable calculation of a distance to/from the SLK location(s), query, by the one or more processors, a first application programming interface (API) for validation of information relating to the SLK location(s) and for coordinate values associated with the SLK location(s), receive, by the one or more processors, based upon validation of information relating to the SLK location(s), the coordinate values associated with the SLK location(s), determine, by the one or more processors and based on the received coordinate values, one or more attributes associated with travel between the locations including at least one travel route between the start and destination locations, the at least one travel route determined by querying a second API, and insert, by the one or more processors, into content displayed on a graphical user interface (GUI) associated with the device, the one or more attributes associated with travel between the locations.

According to a still further aspect, the present invention provides a non-transitory computer-readable medium storing software including instructions executable by one or more computers which, upon execution, cause the one or more computers to receive, by one or more processors associated with a device, location data, wherein the location data includes data input by a user of the device, determine, by the one or more processors, that the location data includes information relating to a start location and a destination location, wherein at least one of the start location and destination location is an SLK location and hence does not include coordinate values that enable calculation of a distance to/from the SLK location(s), query, by the one or more processors, a first application programming interface (API) for validation of information relating to the SLK location(s) and for coordinate values associated with the SLK location(s), receive, by the one or more processors, based upon validation of information relating to the SLK location(s), the coordinate values associated with the SLK location(s), determine, by the one or more processors and based on the received coordinate values, one or more attributes associated with travel between the locations including at least one travel route between the start and destination locations, the at least one travel route determined by querying a second API, and insert, by the one or more processors, into content displayed on a graphical user interface (GUI) associated with the device, the one or more attributes associated with travel between the locations.

### BRIEF DESCRIPTION OF THE DRAWINGS

Embodiments of the invention will now be described in further detail with reference to the accompanying Figures in which:

FIG. 1 illustrates an exemplary system for determining one or more attributes associated with travel between two locations including at least one SLK location.

FIG. 2 illustrates an exemplary flow diagram of a process that enables a user to download, signup and login to an application for interacting with the system illustrated in FIG. 1.

FIG. 3 illustrates an exemplary flow diagram of a process that enables a user to enter location data associated with a start and destination location for a consignment of goods, and receive one or more attributes including at least a distance between the locations.

FIG. 4 illustrates an exemplary flow diagram of a process that enables a user to determine one or more additional attributes associated with travel between the locations including an estimated freight cost.

FIG. 5 illustrates an exemplary flow diagram of a process that enables a user to determine one or more additional attributes associated with travel between the locations including courier company freight quotes.

FIG. 6 illustrates an exemplary flow diagram of a process that enables a user to determine one or more additional attributes associated with travel between the locations including an optimal travel route and guided access.

### DETAILED DESCRIPTION OF EMBODIMENT(S) OF THE INVENTION

The present invention relates to at least a system and method for determining one or more travel route attributes, including at least a travel route (120), associated with travel between two locations of which at least one is a straight line kilometre (SLK) location. According to an embodiment detailed in the enclosed Figures, the system and method uses a recordal or/and transmission device, such as a mobile device (20), in operable communication with one or more application programming interfaces (140, 160, 180) using an application (30) installed on the user device (20).

Pursuant to the embodiment depicted in the Figures, the device (20) is configured to receive location data, e.g. a road name (100A), wherein the location data includes data input by a user (10) of the device (20), determine that the location data includes information relating to a start location (e.g. 110) and a destination location (e.g. 90), wherein at least one of the start location and destination location is a SLK location, i.e. a location that does not include coordinate values enabling calculation of a distance to or from the SLK location. The application (30) further enables the device (20) to query a first application programming interface (API) (140) for validation of information relating to the SLK location(s) and for coordinate values (100C) associated with the SLK location(s), receive, based upon validation of the information, the coordinate values (100C) associated with the SLK location(s), and determine one or more attributes associated with travel between the locations including at least one travel route (120) between the start (110) and destination (90) locations. The at least one travel route (120) is determined by a querying a second API (180) and the one or more attributes including the travel route (120) are inserted into content displayed on a graphical user interface (GUI), e.g. interface (170), associated with the device (20).

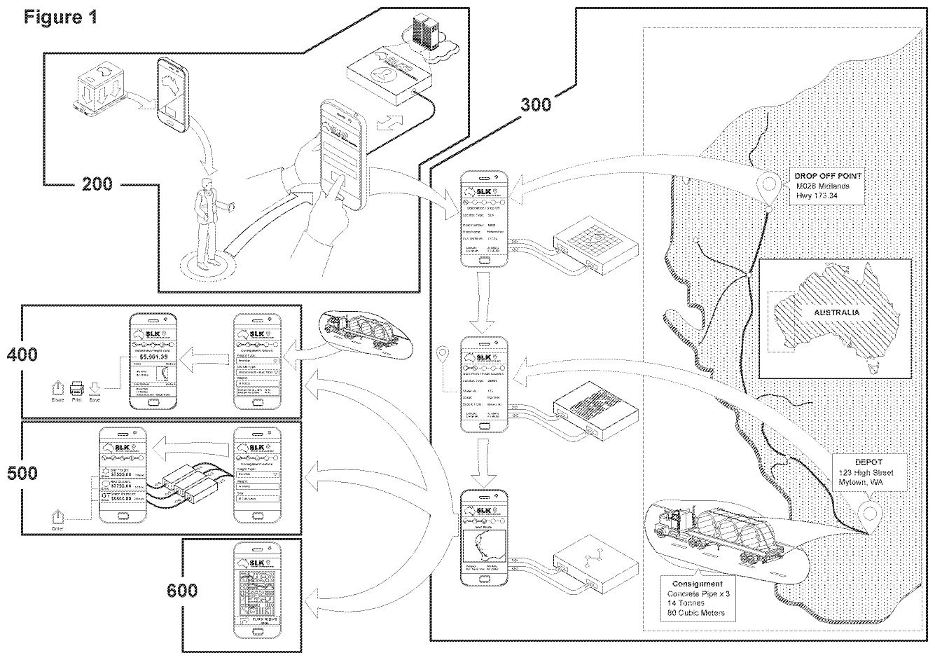

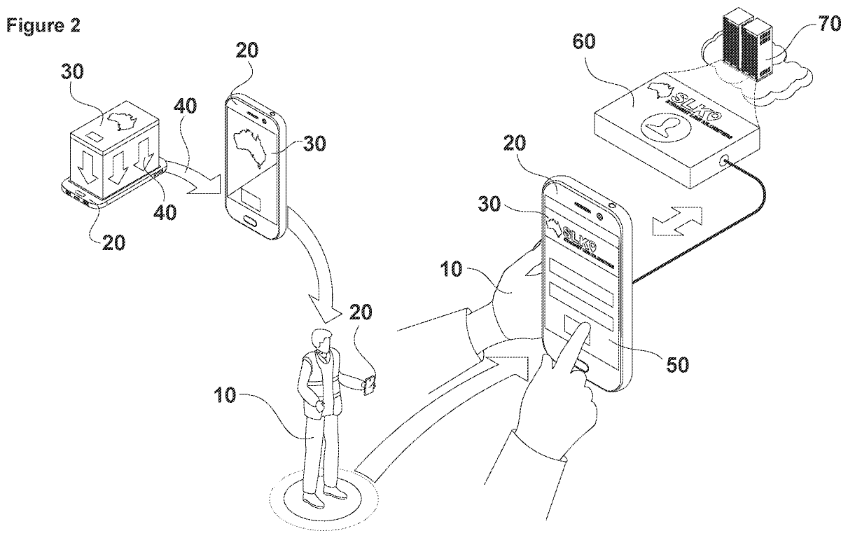

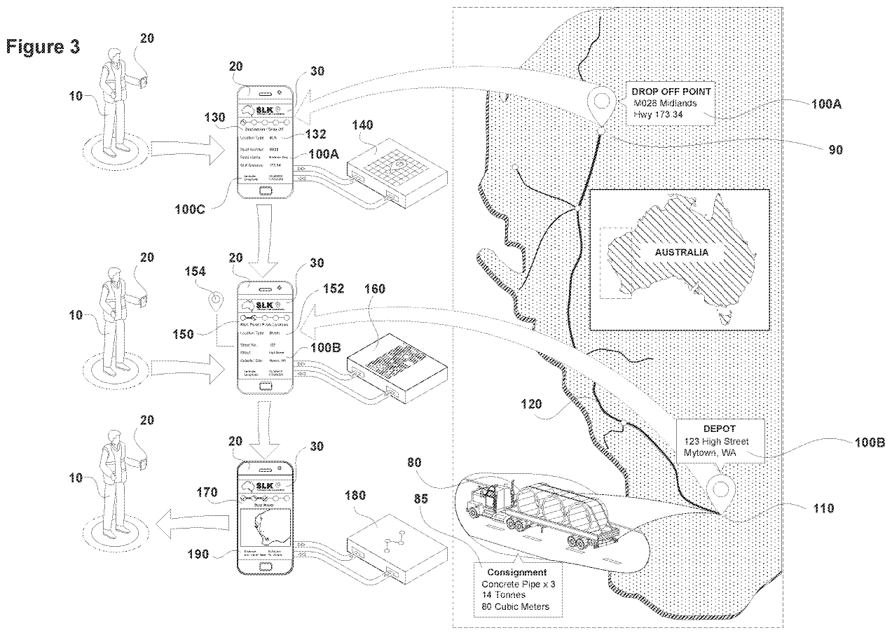

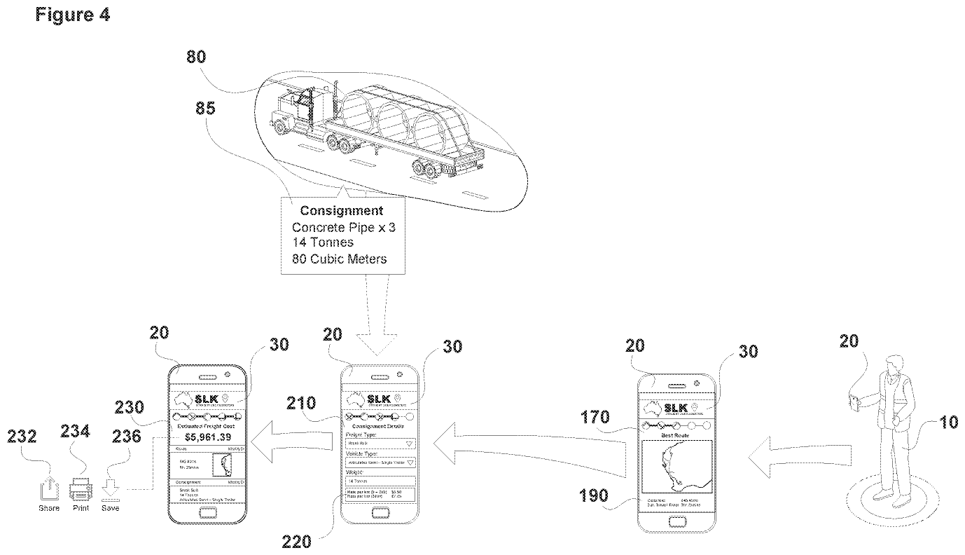

With reference to FIG. 1, an overview of the system and method of the present invention is provided, which includes an embodiment of the use of the recordal and transmission device (20), which in the example shown is a mobile device (20) associated with user (10), to enable interaction with the application (30). FIG. 1 is divided into segments which are further expanded in the subsequent FIGS. 2-6. In FIG. 1, segment (200) shows the user (10) installing the application (30) and logging in to the application, and this is expanded in FIG. 2. Segment (300) of FIG. 1 shows the user entering location data including at least a start location (110) or a destination location (90). In the embodiment shown, the destination location is an SLK location and the start location is a physical street address. In particular, the start location (110) is a depot from which a consignment (85) is to be transported using vehicle (80). This process gives rise to the generation of at least one attribute associated with travel between the locations, including at least a travel route (120), which is expanded in FIG. 3. Segments (400), (500) and (600), expanded in FIGS. 4, 5 and 6 respectively, demonstrate the generation of additional attributes associated with travel between the two locations based on the determined travel route (120), including freight cost estimation (230), courier company freight quotes (260) and route instructions (272).

As mentioned above, FIG. 2 shows in greater detail the segment (200) from FIG. 1. In particular, FIG. 2 shows a user (10), who may be an employee of a company assigned to transport a consignment (85) from a depot (100B) to an SLK drop off point (100A), installing the application (30) on their mobile device (20). The process of installing the application (30) onto the user device (20) according to an embodiment is identified under reference numeral 40 in FIG. 2, and the subsequent process of registering and logging in to the application (30) and enabling the user (10) to enter their credentials (typically a user name and password) according to an embodiment is identified under reference 50 in FIG. 2. Each user (10), which may include the person(s) tasked with transporting the consignment, depot personnel tasked with seeking freight cost estimates for transporting the consignment, a manager responsible for overseeing transport of the consignment, etc, will be required to register and log in using their log in details. Registration of a new user will create a new user account, and new users may be requested to provide details about themselves. Registration may also require payment of a fee to use the application (30).

Also shown in FIG. 2 is a register (60) of users (10) registered to use the application (30). During registration and log in, the application (30) may communicate with the register (60) for purposes including establishing a new user account (in the case of new users) and verifying user information (in the case of previously registered users seeking to log in). The register (60) may be stored and maintained using infrastructure (70), which may be local or cloud-based, e.g. local or cloud-based servers.

FIG. 3 shows in greater detail segment (300) of FIG. 1. In particular, FIG. 3 shows how, according to an embodiment, a travel route (120) may be determined between a start location (110) and destination location (90). In this particular embodiment, the start point (110) is the depot (100B) from which the user (80) is to collect the consignment (85), hence the start location (110) is a physical address. Further, the destination location (90) is a location having no physical address, i.e. a SLK location (100A), which in the embodiment shown is a drop off point on a particular road having road number “M028” and a road name “Midlands Highway”. However, it is to be understood that there may be scenarios where both the start location and the destination location are SLK locations, or where the destination location is a physical address and the start location, i.e. the pick up point, is a SLK location.

A first step in the process of determining a travel route (120) between the locations is for the user to enter location data including information associated with the SLK location(s). In the embodiment shown, the SLK location is the destination location (90), and interface (130) provides functionality that enables the user (10) to firstly select the location “type”, i.e. SLK, and then enter information relating to the destination (90) including for example the abovementioned road number and road name. The application 30 may use, e.g. query, an application programming interface (API) (140) to convert the location information provided into latitude and longitude coordinates (100C) which are also shown in interface (130).

In this regard, in an embodiment, once a specific location has been entered, an API automatically retrieves corresponding SLK co-ordinates and the distance from the start location to the SLK location is then calculated.

The second step shown in FIG. 2 is entry of start location information, i.e. entry of information associated with the physical address of depot (100B). Such address information may already be saved (154) with the application (30), or the address details (100B) may be entered for the first time following selection of a location type which in the embodiment shown is “Street” (152). Latitude and longitude coordinates associated with the physical address (100B) may already be saved (154) or made accessible by application (30). Alternatively, the application (30) may use a further application programming interface (API) (160) to convert the physical address provided into latitude and longitude coordinates. Such APIs (140, 160) may also perform verification of the location information entered by the user before providing permission to access to the latitude and longitude coordinates.

Accordingly, a skilled reader will appreciate that determination of one or more attributes associated with travel between the start location (110) and destination location (90), including at least determination of a travel route (120) between the locations, is based at least on coordinate values associated with each of the start location (110) and destination location (90).

The interface (130) and or (150) may provide alternative means for location information to be entered by the user (10). For example, an interactive map similar to that which is shown in the enlarged view of FIG. 3 may be presented to the user (10) which would allow the user (10) to zoom in and select a location on the map. Such selection may cause the application (30) to identify the particular road name/number, which subsequently enables retrieval of the latitude/longitude coordinates associated with same (as described earlier). It is to be understood that the determined one or more travel route attributes, including for example the travel route (120), may then be inserted for display on the same interactive map.

The travel route (120) may be determined using a further API (180), e.g. by querying the API (180) based on the longitude/latitude coordinates associated with the start and destination locations. In doing so, more than one travel route may be determined and the application (30) may be configured to select an optimal travel route of the two or more travel routes retrieved using API (180). Further, an optimal travel route may be determined based on, for example, the shortest distance between the locations and/or the earliest estimated time of arrival. Additional travel route attributes (190) including distance, e.g. straight line kilometre distance or travel distance, and estimated travel time, may also be inserted for display in interface (170), or inserted into an interactive map, upon determination of the travel route (120). Selection of an optimal travel route may also be based upon preference data input by the user (not shown), which may include, for example, a preference to avoid low bridges and/or to avoid restricted roads.

Whilst not shown in the Figures, the application (30) may also enable the user to enter additional consignment details relating to the goods requiring transportation. In the example shown, the consignment (80) is a collection of concrete pipes, and the additional consignment details (85) entered may include, for example, type, size, weight and shipping restrictions. Additional consignment data may be input by the user (10), as shown by example in FIG. 4, where the user (10) inputs freight rates for subsequent utilization as reference data enabling calculation of a freight cost estimate (230). The skilled reader will understand that once a distance associated with travel route (120) is calculated and a freight rate, e.g. $X per kilometre, is entered, a freight cost estimate can be calculated. This aspect of the application (30) is shown in the example interface (210) of FIG. 4, which also demonstrates how an estimated freight cost (230) may be shared (232) with other users, printed (234), or saved (236).

Freight rates may be entered by the user (10) prior to entering the location data, in which case the freight cost estimate (230) may be automatically inserted for display in the interactive map once the location data is entered and the travel route (120) retrieved and displayed on the interactive map. By displaying the map, travel route (120) and an additional attribute such as a freight estimate (230) in the same interface content, fewer input steps are required by the user (10) and hence computer and network usage is likely to be minimized. If the freight rates (220) are entered subsequent to determination of the travel route (120), then the freight cost estimate (230) will not automatically be inserted into the interactive map but may subsequently appear, i.e. after the freight rates (220) are entered. It is envisaged that the interactive map (or any other interface used to present the determinations to the user) will be a display from which the user can navigate to/away, and where new data is entered or new data is made available to the application (30), navigating to that interface will cause the presented determinations to take into account the new data. In other words, the interface, whether it be an interactive map or table, will automatically provide the most up-to-date information to the user (10).

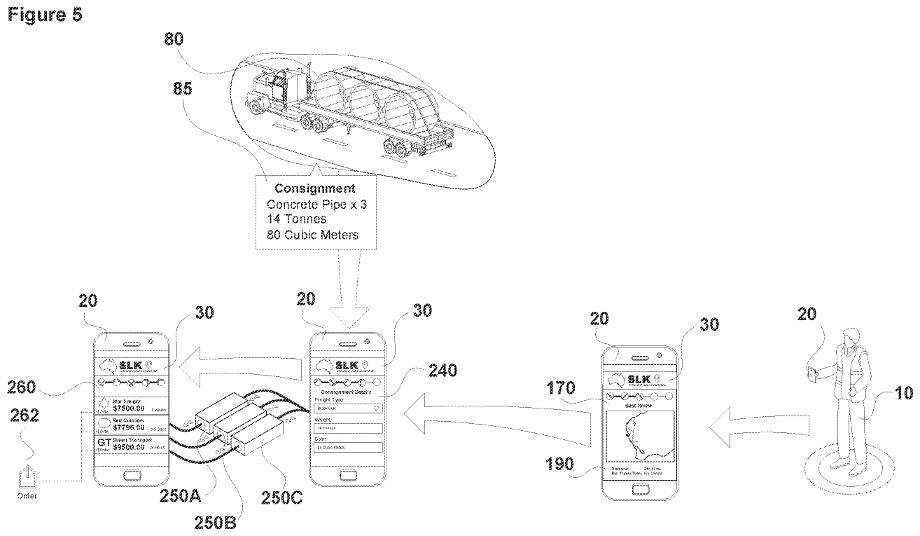

FIG. 5 shows in greater detail segment (500) of FIG. 1, and in particular, the generation of an additional travel route attribute in the form of one or more quotes from courier companies capable of transporting the consignment from the start location to the destination location based on the determined travel route (120). A courier company will generally provide online functionality enabling their customers to obtain freight quotes, and such services (250A, 250B and 250C) are displayed in FIG. 5. The application (30) may be configured to access such services and display a listing (260) of freight quotes (260) from each courier company for transporting the consignment (85). FIG. 5 also shows a freight detail entry screen (240) which allows the user to enter the details of the consignment (85), similar to the consignment detail entry interface (210) of FIG. 4. Accordingly, one of the additional attributes associated with travel between the locations includes one or more freight quotes (260) retrieved from freight companies based on the consignment data. In an embodiment, the application (30) may also enable user (10) to make an order (262) with a selected freight company, or at least provide access to the online ordering system associated with the select freight company.

The skilled reader will appreciate, in view of the embodiments depicted in FIGS. 4 and 5, that a user is not only able to calculate a general freight cost estimate associated with transporting a consignment between two locations, but may subsequently retrieve freight quotes directly from freight companies and order services of a particular freight company, using functionality provided by a single application (30) operating on the user's mobile device (20). Accordingly, operation of the device (20) is improved since the user is enabled to complete such tasks far more efficiently and utilizing reduced manual and computing resources since the user is no longer required to combine manual and computer-implemented processes for the purpose of determining a travel route (involving a SLK start or destination location) and associated attributes. In other words, use of the application (30) provides a single platform in which user-input location data can be coupled with additional location data from one or more application programming interfaces (APIs) in order to output at least a travel route (120) for the user (10) and additional travel-related attributes such as an optimal travel route (in the case of two or more available routes), the distance between the locations, an estimated travel time, and freight estimates/quotes.

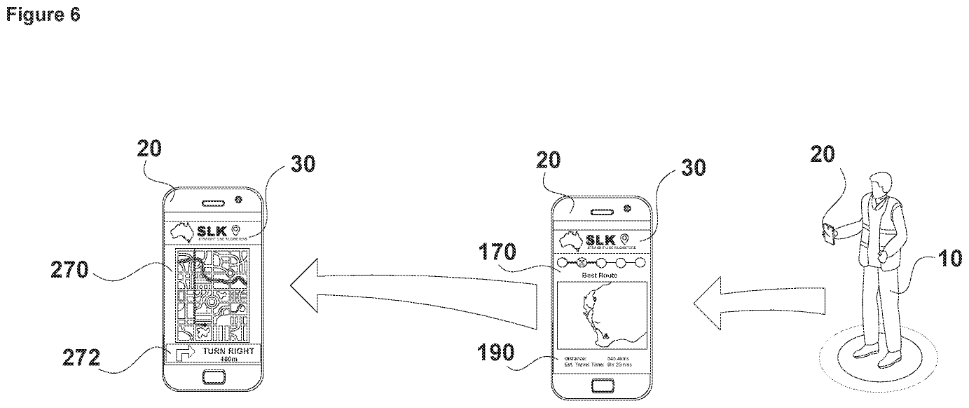

Once a travel route (120) or an optimal travel route is determined, the application (30) may also provide navigation guidance to the user (10). FIG. 6 shows in greater detail segment (600) of FIG. 1, and relates to the application's ability to present a route navigation screen (270) to the user, which may be the same or different to the abovementioned interactive map, as well as route instructions (272). Accordingly, the one or more attributes associated with travel between the start location (110) and destination location (90) may further include determination and display of a “best route” together with navigation instructions associated with the selected route, such as turn instructions, etc.

The user device (20) could be a tablet computer, a smartphone, a laptop computer, a desktop computer, or another type of computing device. The user device (20) may include a display that provides an interface for the user to input and/or view information. For example, a user could interact with the device using a program run on a laptop computer, such as a text-based chat program, a voice-based communication program, and/or a video-based communication program. Alternatively, in some cases, the user device (20) could be a telephone (e.g., a landline, cell phone, etc.).

Data associated with the application (30), including data input into fields of the application (30), may be stored in read-only application storage associated with the application (30), or alternatively using remote infrastructure (70) which may be in the form of one or more servers which may, in turn, be in the form of a single computer, particular computing resources of a single computer, a plurality of computers communicating with one another, or a network of remote servers (e.g. cloud).

The user device (20) could communicate with the server for the abovementioned purposes, or for the purpose of receiving updates over a network. In some embodiments, the network may be a wide segment network (“WAN”), e.g., the Internet. In other embodiments, the network may be a local segment network (“LAN”). For example, in a more remote location far from a metropolitan segment, the Internet may not be available. In yet other embodiments, the network may be a combination of a WAN and a LAN. In embodiments where the mobile device (20) is a phone (e.g., a landline or a cell phone), the communication may pass through a telecommunications network and/or a wide segment network.

It will be appreciated by skilled persons in the relevant field of technology that numerous variations and/or modifications may be made to the invention as detailed in the embodiments without departing from the spirit or scope of the invention as broadly described. The present embodiments are, therefore, to be considered in all aspects as illustrative and not restrictive.

Throughout this specification and claims which follow, unless the context requires otherwise, the word “comprise”, and variations such as “comprises” and “comprising”, will be understood to imply the inclusion of a stated feature or step, or group of features or steps, but not the exclusion of any other feature or step or group of features or steps.

1. A computer-implemented method comprising:
receiving, by one or more processors associated with a device, location data,
wherein the location data comprises data input by a user of the device;
determining, by the one or more processors, that the location data comprises information relating to a start location and a destination location,
wherein at least one of the start location and destination location is an SLK location and hence does not comprise coordinate values that enable calculation of a distance to/from the SLK location(s);
querying, by the one or more processors, a first application programming interface (API) for validation of information relating to the SLK location(s) and for coordinate values associated with any SLK location(s);
receiving, by the one or more processors, based upon validation of information relating to the SLK location(s), the coordinate values associated with the SLK location(s);
determining, by the one or more processors and based on the received coordinate values, one or more attributes associated with travel between the locations including:
at least one travel route between the start and destination locations, the at least one travel route determined by querying a second API; and
inserting, by the one or more processors, into content displayed on a graphical user interface (GUI) associated with the device, the one or more attributes associated with travel between the locations.

2. A method according to claim 1, wherein determining the one or more attributes is based at least upon coordinate values associated with each of the start location and destination location.

3. A method according to claim 1, further comprising:
determining, by the one or more processors, that coordinate values associated with the start location are not available based on data input by the user or stored in memory, and
querying, by the one or more processors, a third API for validation of information relating to the start location and for coordinate values associated with the start location.

4. A method according to claim 1, wherein the coordinate values associated with each of the start and destination locations represent longitude and latitude coordinates of a Global Positioning System (GPS).

5. A method according to claim 1, wherein the one or more attributes further comprise a distance between the locations based on each of the one or more travel routes, wherein the distance comprises:
a straight line kilometre distance between the locations, or
a travel distance between the locations.

6. A method according to claim 1, further comprising:
receiving, by the one or more processors, travel route preference data input by the user of the device, and
when two or more travel routes are determined, selecting, by the one or more processors, an optimal travel route of the two or more travel routes based on the distance between the locations and the preference data.

7. A method according to claim 1, further comprising:
inserting into content displayed on the GUI, by the one or more processors, detailed route navigation for guiding the user from a current location to the destination location based upon determination of the one or more travel routes or selection of the optimal travel route.

8. A method according to claim 1, further comprising:
receiving, by the one or more processors, consignment data input by the user of the device, the consignment data including one or more freight rates, and
wherein the one or more attributes associated with travel between the locations further comprises a freight cost estimate determined based upon the distance between the locations and the consignment data including the one or more freight rates.

9. A method according to claim 1, wherein the one or more attributes associated with travel between the locations further comprises one or more freight quotes based upon quotes retrieved, by the one or more processors, from one or more freight companies according to the consignment data.

10. (canceled)

11. A method according to claim 1, wherein receiving location data comprises receiving a user selection of a start and destination location on an interactive map displayed on the GUI, wherein the one or more attributes, once determined, are inserted for display on the interactive map.

12. (canceled)

13. A system comprising:
one or more computers and one or more storage devices storing instructions that are operable, when executed by the one or more computers, to cause the one or more computers to:
receive, by one or more processors associated with a device, location data,
wherein the location data comprises data input by a user of the device;
determine, by the one or more processors, that the location data comprises information relating to a start location and a destination location,
wherein at least one of the start location and destination location is an SLK location and hence does not comprise coordinate values that enable calculation of a distance to/from the SLK location(s);
query, by the one or more processors, a first application programming interface (API) for validation of information relating to the SLK location(s) and for coordinate values associated with the SLK location(s);
receive, by the one or more processors, based upon validation of information relating to the SLK location(s), the coordinate values associated with the SLK location(s);
determine, by the one or more processors and based on the received coordinate values, one or more attributes associated with travel between the locations comprising:
at least one travel route between the start and destination locations, the at least one travel route determined by querying a second API; and
insert, by the one or more processors, into content displayed on a graphical user interface (GUI) associated with the device, the one or more attributes associated with travel between the locations.

14. A system according to claim 13, wherein determining the one or more attributes is based at least upon coordinate values associated with each of the start location and destination location.

15. A system according to claim 13, further comprising:
determining, by the one or more processors, that coordinate values associated with the start location are not available according to data input by the user or stored in memory, and
querying, by the one or more processors, a third API for validation of information relating to the start location and for coordinate values associated with the start location.

16. A system according to claim 13, wherein the coordinate values associated with each of the start and destination locations represent longitude and latitude coordinates of a Global Positioning System (GPS).

17. A system according to claim 13, wherein the one or more attributes further comprise a distance between the locations based upon each of the one or more travel routes, wherein the distance comprises:
a straight line kilometre distance between the locations, or
a travel distance between the locations.

18. A system according to claim 13, further comprising:
receiving, by the one or more processors, travel route preference data input by the user of the device, and
when two or more travel routes are determined, selecting, by the one or more processors, an optimal travel route of the two or more travel routes based upon the distance between the locations and the preference data.

19. A system according to claim 13, further comprising:
inserting into content displayed on the GUI, by the one or more processors, detailed route navigation for guiding the user from a current location to the destination location based upon determination of the one or more travel routes or selection of the optimal travel route.

20. A system according to claim 13, further comprising:
receiving, by the one or more processors, consignment data input by the user of the device, the consignment data including one or more freight rates, and
wherein the one or more attributes associated with travel between the locations further comprises a freight cost estimate determined according to the distance between the locations and the consignment data including the one or more freight rates.

21. A system according to claim 13, wherein the one or more attributes associated with travel between the locations further comprises one or more freight quotes based upon quotes retrieved, by the one or more processors, from one or more freight companies according to the consignment data.

22-24. (canceled)

25. A non-transitory computer-readable medium storing software comprising instructions executable by one or more computers which, upon execution, cause the one or more computers to:
receive, by one or more processors associated with a device, location data, wherein the location data comprises data input by a user of the device;
determine, by the one or more processors, that the location data comprises information relating to a start location and a destination location,
wherein at least one of the start location and destination location is an SLK location and hence does not comprise coordinate values that enable calculation of a distance to/from the SLK location(s);
query, by the one or more processors, a first application programming interface (API) for validation of information relating to the SLK location(s) and for coordinate values associated with the SLK location(s);
receive, by the one or more processors, based upon validation of information relating to the SLK location(s), the coordinate values associated with the SLK location(s);
determine, by the one or more processors and based on the received coordinate values, one or more attributes associated with travel between the locations comprising:
at least one travel route between the start and destination locations, the at least one travel route determined by querying a second API; and
insert, by the one or more processors, into content displayed on a graphical user interface (GUI) associated with the device, the one or more attributes associated with travel between the locations.
